(19) United States
(12) Patent Application Publication
(10) Pub. No.: US 2008/0032907 A1
(43) Pub. Date: Feb. 7, 2008

(54) Shaver head cleanser

(76) Inventor: Bernard Patenaude, Quebec (CA)

Correspondence Address: Bernard Patenaude, 966 de la RITOURNELLE, L'ANCLENNE-LORETTE, Quebec, QC, G2E 2K5, US

(21) Appl. No.: 11/496,644

(22) Filed: Aug. 1, 2006

(51) Int. Cl. C09D 9/00

(52) U.S. Cl. 510/202

(57) ABSTRACT

A solid form cleanser composition for shaver head, which comprises an effective amount of sodium bicarbonate, citric acid, boric acid, colorant, flavour and fragrance which are dissolved in an effective amount of warm water sufficient to dissolve the solid form composition and to completely cover the shaver head for a sufficient time to effect the desired cleaning.

### BACKGROUND OF THE INVENTION

1. Field of the Invention

This invention relates to a solid form cleanser composition for shaver head which is employed to dislodge whiskers without brushing or other help.

2. Description of the Related Art

It has been recognized as desirable to provide a cleanser or device for shaver head.

A search of prior art records has unveiled the following patents:

U.S. Pat. No. 5,060,376 issued in 1991 to Berry;

U.S. Pat. No. 6,530,150 issued in 2003 to Barish;

U.S. Pat. No. 4,054,963 issued in 1977 to Taylor; and

U.S. Pat. No. 6,385,850 issued in 2002 to Coulthard.

To overcome the prior art deficiencies, in accordance with the teachings of the invention, there is disclosed a solid form cleanser composition which is relatively simple and gives good results.

### SUMMARY OF THE INVENTION

The gist is to provide a solid form cleanser composition for shaver head.

### DETAILED DESCRIPTION OF THE INVENTION

In accordance with the present invention there is provided a solid form cleanser composition for shaver head, and which comprises an effective amount of sodium bicarbonate, citric acid, boric acid, colorant, flavour and fragrance which are dissolved in warm water. Accordingly, while the preferred embodiment of the invention has been described above, it will be recognized and understood that various modifications may be made in the invention and the appended claims are intended to cover all such modifications which may fall within the spirit and scope of the invention.

Experimentation:

The tests have been effectuated.

Results:

Concentration tested:

| | |
|---|---|
| Sodium bicarbonate | 70% |
| Citric acid | 15% |
| Boric acid | 15% |
| Physical State: | Solid Form |

Discuss:

The results obtained are very satisfactory when the solid form cleanser composition for shaver head is employed in an effective amount of warm water sufficient to dissolve the solid form composition and to completely cover the shaver head for a sufficient time to effect the desired cleaning, and the cleaning time may be achieved in the meantime of about 3 to 5 minutes.

1. A shaver head cleanser composition which comprises an effective amount of sodium bicarbonate, citric acid, and boric acid, to be dissolved in an effective amount of warm water.

2. The shaver head cleanser composition of claim 1 wherein the sodium bicarbonate is present in an amount of 70% by weight of the total composition.

3. The shaver head cleanser composition of claim 1 wherein the citric acid is present in an amount of 15% by weight of the total composition.

4. The shaver head cleanser composition of claim 1 wherein the boric acid is present in an amount of 15 % by weight of the composition.

5. (canceled)

6. (canceled)

7. (canceled)

8. (canceled)

9. (canceled)
